(19) United States
(12) Patent Application Publication
(10) Pub. No.: US 2026/0127101 A1
(43) Pub. Date: May 7, 2026

(54) TEST CASE CLASSIFICATION APPARATUS AND TEST CASE CLASSIFICATION PROGRAM

(71) Applicant: Sony Interactive Entertainment Inc., Tokyo (JP)

(72) Inventor: Akito Ota, Tokyo (JP)

(73) Assignee: Sony Interactive Entertainment Inc., Tokyo (JP)

(21) Appl. No.: 19/351,796

(22) Filed: Oct. 7, 2025

(30) Foreign Application Priority Data
Nov. 6, 2024 (JP) 2024-194537

(51) Int. Cl. G06F 11/3668; G06F 11/3698

(52) U.S. Cl. CPC G06F 11/3688; G06F 11/3698

(57) ABSTRACT

Provided is a test case classification apparatus including a memory and a processor. The processor includes a test case classification section that performs classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case, and a result output section that outputs a result of the classification performed by the test case classification section.

### CROSS REFERENCE TO RELATED APPLICATION

This application claims the benefit of Japanese Priority Patent Application JP 2024-194537 filed Nov. 6, 2024, the entire contents of which are incorporated herein by reference.

### BACKGROUND

The present disclosure relates to a test case classification apparatus and a test case classification program.

In the past, there has been known a software development system capable of determining whether to adopt automated testing or manual testing when specifications are changed (see Japanese Patent Laid-Open No. 2014-92980 (hereinafter, referred to as Patent Document 1), for example).

The software development system described in Patent Document 1 includes a test determination system, a test system, a version management system, a release management system, and an information and communications technology (ICT) system.

When the specifications of software are changed, the test determination system estimates efforts for automated testing and efforts for manual testing and presents which of them includes fewer efforts. More specifically, for each test case in which a specification change has been made, the test determination system acquires the number of tests and the number of steps, calculates the efforts for automated testing and the efforts for manual testing, and determines a test mode including fewer efforts.

### SUMMARY

In the software development system described in Patent Document 1, whether a test case should be run manually or automatically is determined depending on how many testing efforts will be made. Thus, in a case where one test case includes a few testing efforts but it takes a relatively longer time to execute each of steps included in the one test case, a problem arises that the amount of time that it takes to run the test case may not always be grasped from the testing efforts. Further, some test cases are fit for manual testing but others are not, and likewise for automated testing. Some test cases can be completed more quickly through manual testing than automated testing. For this reason, according to the configuration described in Patent Document 1, there is a possibility that the amount of time required to conduct a test based on all the test cases to be run may not be reliably shortened, and therefore, the test may possibly not be completed within a test period.

Accordingly, there has been demanded a configuration that can perform the classification of test cases in such a way that a test can be completed within a test period.

A test case classification apparatus according to a first embodiment of the present disclosure includes a memory and a processor. The processor includes a test case classification section that performs classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case, and a result output section that outputs a result of the classification performed by the test case classification section.

A test case classification program according to a second embodiment of the present disclosure is a program for a computer including a memory and a processor and includes, by a test case classification section, performing classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case, and by a result output section, outputting a result of the classification performed by the test case classification section.

### BRIEF DESCRIPTION OF THE DRAWINGS

FIG. 1 is a schematic diagram depicting a configuration of a test case classification system according to an embodiment;

FIG. 2 is a diagram depicting an example of a test case group according to the embodiment;

FIG. 3 is a block diagram depicting a configuration of a test case classification apparatus according to the embodiment;

FIG. 4 is a block diagram depicting a functional configuration of a processor according to the embodiment;

FIG. 5 is a flowchart of a test case classification process according to the embodiment;

FIG. 6 is a flowchart of a first classification process according to the embodiment; and

FIG. 7 is a flowchart of a second classification process according to the embodiment.

### DETAILED DESCRIPTION OF THE PREFERRED EMBODIMENT

Hereinafter, an embodiment of the present disclosure will be explained with reference to the drawings.

### Schematic Configuration of Test Case Classification System

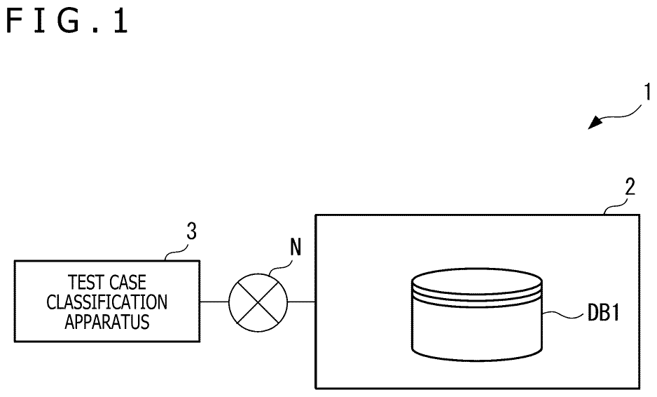

FIG. 1 is a schematic diagram depicting a configuration of a test case classification system 1 according to the present embodiment.

As depicted in FIG. 1, the test case classification system 1 according to the present embodiment includes a test case management server 2 that manages test cases of system software and a test case classification apparatus 3. The test case classification apparatus 3 performs classification of test cases acquired from the test case management server 2, by setting a mode of running the test cases. That is, the test case classification apparatus 3 classifies the acquired test cases into test cases to be run through manual testing and test cases to be run through automated testing, which will be explained in detail later.

Hereinafter, each component of the test case classification system 1 will be explained in detail.

### Configuration of Test Case Management Server

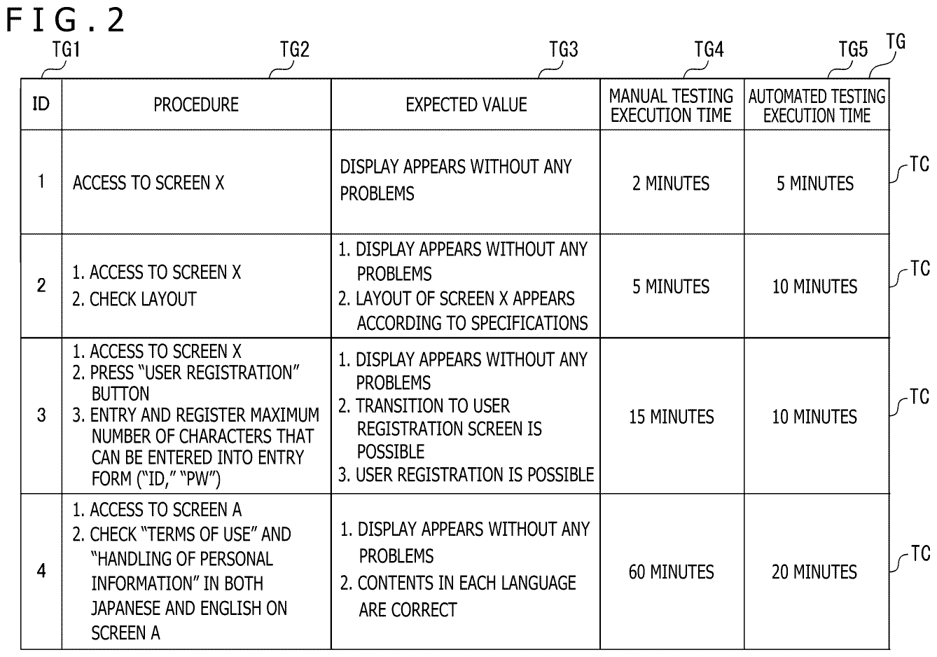

FIG. 2 is a diagram depicting an example of a test case group TG.

The test case management server 2 holds a test case management database DB1.

In the test case management database DB1, a test case group including test cases of system software to be tested is managed. By way of example, the test case group TG, which is illustrated as an example in FIG. 2, is managed in the test case management database DB1.

### Configuration of Test Case Group

Here, an explanation of the test case group TG including a plurality of test cases TC is given.

The test case group TG, which is illustrated as an example in FIG. 2, is a set of test cases TC each describing test contents for system software to be tested. That is, the test case group TG is a table in which at least one test case TC is described row by row, as depicted in FIG. 2.

The test case group TG includes a test identification (ID) field TG1, a procedure field TG2, an expected value field TG3, a manual testing execution time field TG4, and an automated testing execution time field TG5. In other words, one test case TC includes a test ID, a procedure, an expected value, a manual testing execution time, and an automated testing execution time. The test case group TG may further include an entry field in which a test result is entered.

In the test ID field TG1, a test case ID for identifying the test case TC is specified.

In the procedure field TG2, a test procedure is specified.

In the expected value field TG3, an expected value is specified. The expected value represents a correct test result which is obtained when a test is conducted according to the procedure specified in the procedure field TG2 of the corresponding test case TC. That is, the expected value is defined according to the specifications of the system software to be tested and represents a result of the test conducted according to the corresponding procedure.

In the manual testing execution time field TG4, the manual testing execution time that represents the amount of time required to manually execute the test based on the test case TC is specified.

In the automated testing execution time field TG5, the automated testing execution time that represents the amount of time required to automatically execute the test based on the test case TC is specified. It is to be noted that, when the execution of automated testing based on the test case TC is not allowed, “automation is not available” is specified in the automated testing execution time field TG5.

### Configuration of Test Case Classification Apparatus

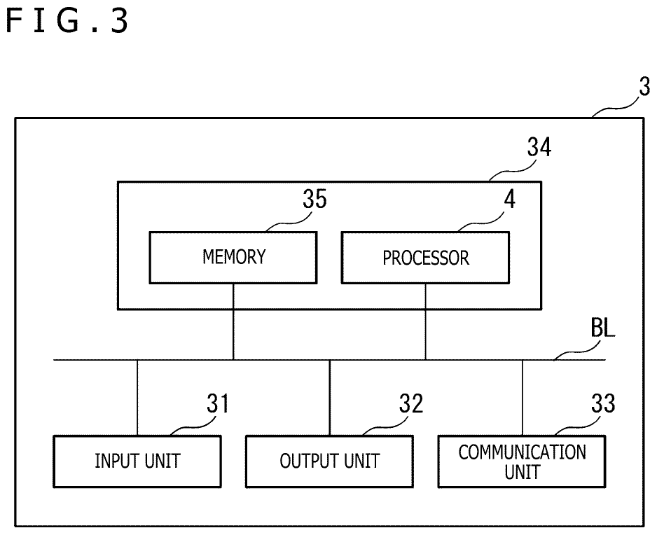

FIG. 3 is a block diagram depicting the configuration of the test case classification apparatus 3.

The test case classification apparatus 3 depicted in FIG. 1 can communicate with the test case management server 2 over a network N. The test case classification apparatus 3 acquires, from the test case management server 2, a test case TC that is included in a plurality of test cases TC describing test contents for system software to be tested and that is to be run, and classifies the acquired test case TC as a test case based on which a test is executed at least either manually or automatically. More specifically, the test case classification apparatus 3 compares the manual testing execution time and the automated testing execution time for each of the acquired test cases to be run, sets a running mode of each of the test cases, and performs classification of the test cases into test cases to be run through manual testing and test cases to be run through automated testing.

As depicted in FIG. 3, the test case classification apparatus 3 includes an input unit 31, an output unit 32, a communication unit 33, and a control unit 34. The input unit 31, the output unit 32, the communication unit 33, and the control unit 34 are mutually connected in a communicable manner via a bus line BL.

### Configurations of Input Unit, Output Unit, and Communication Unit

The input unit 31 receives an input operation performed by an operator of the test case classification apparatus 3 and outputs an operation signal corresponding to the operator's input operation to the control unit 34. That is, the input unit 31 receives an operation of inputting a test period, an operation of inputting a test condition, an operation of selecting a priority item, and an operation of designating a test scope. The input unit 31 is configured as an input device such as a keyboard or a pointing device. For example, the pointing device is a mouse or a touch panel.

The output unit 32 outputs a result of processing by the control unit 34. Examples of the output unit 32 include a display and a printer.

The communication unit 33 communicates with an external apparatus such as the test case management server 2 over the network N under control of the control unit 34.

### Configuration of Control Unit

The control unit 34 controls the test case classification apparatus 3. By way of example, the control unit 34 executes predetermined processing according to an operation signal inputted from the input unit 31 and outputs an execution result of the processing to the output unit 32. The control unit 34 includes a memory 35 and a processor 4.

The memory 35 includes a work memory for the processor 4 and a storage device storing a program and data necessary for the operation of the test case classification apparatus 3.

The work memory temporarily stores at least part of a program read out from the storage device. In addition, the work memory temporarily stores a test case TC acquired from the test case management server 2 via the communication unit 33.

The storage device stores a test case classification program for causing the processor 4 to execute an operating system (OS) and a test case classification process, which will be described later. That is, the memory 35 including the storage device is a recording medium having the test case classification program recorded therein.

### Configuration of Processor

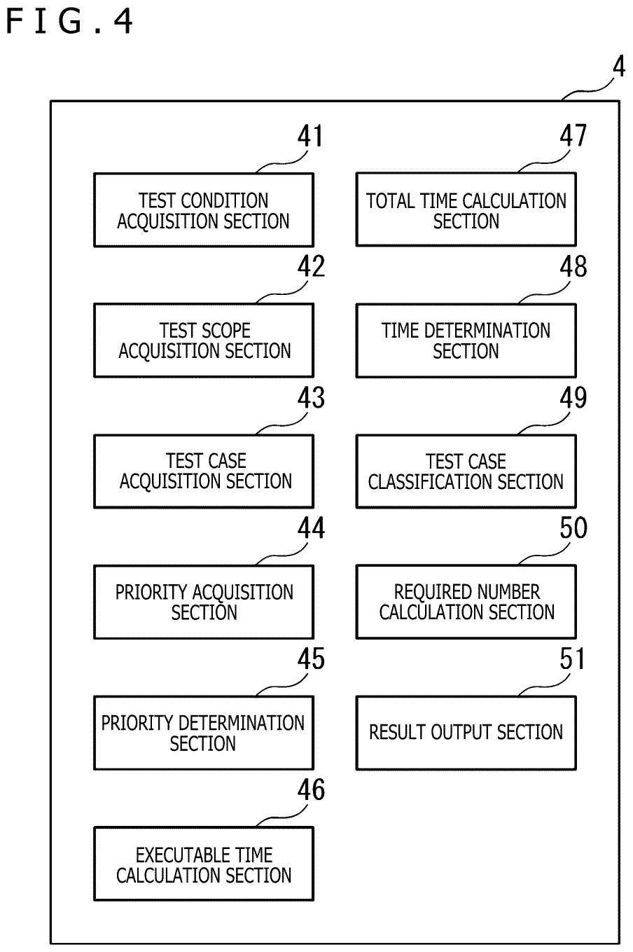

FIG. 4 is a block diagram depicting a functional configuration of the processor 4.

The processor 4 executes the OS stored in the storage device of the memory 35 and controls the test case classification apparatus 3. In addition, by executing the test case classification program stored in the storage device of the memory 35, the processor 4 performs the test case classification process, which will be explained later. It is to be noted that it is sufficient if the test case classification apparatus 3 includes at least one processor 4, and the number of the processors 4 included in the test case classification apparatus 3 can be changed appropriately.

As depicted in FIG. 4, the processor 4 includes a test condition acquisition section 41, a test scope acquisition section 42, a test case acquisition section 43, a priority acquisition section 44, a priority determination section 45, an executable time calculation section 46, a total time calculation section 47, a time determination section 48, a test case classification section 49, a required number calculation section 50, and a result output section 51, those sections functioning upon execution of the test case classification program.

The test condition acquisition section 41 corresponds to a test period acquisition section and acquires test conditions. The test conditions include a test period that is specified by the start date and time and the end date and time, the number of testers who can execute manual testing, a period of time during which manual testing can be executed by the testers, the number of test execution apparatuses capable of executing automated testing, and a period of time during which automated testing can be executed by the test execution apparatuses, for example. These test conditions are inputted to the input unit 31 by, for example, an operator of the test case classification apparatus 3.

The test scope acquisition section 42 acquires a scope of a test to be executed for system software. For example, in a case where the entirety of the system software is to be tested, the test execution scope covers “all test cases.” Alternatively, in a case where some of source codes of the system software are to be tested, for example, the test execution scope covers “test cases related to some of source codes.” Such a test scope is inputted to the input unit 31 by, for example, an operator of the test case classification apparatus 3.

The test case acquisition section 43 acquires, from the test case management server 2, at least one test case TC corresponding to the execution scope acquired by the test scope acquisition section 42. The test cases TC that are acquired by the test case acquisition section 43 are test cases to be run.

The priority acquisition section 44 acquires a priority item regarding a test for the system software. The priority item is inputted or selected through the input unit 31 by, for example, an operator of the test case classification apparatus 3. In the present embodiment, the priority item includes a “cost” and a “quality.” However, the priority item is not limited to them, and may include other items or may be any of the other items.

The priority determination section 45 determines what is indicated by the priority item acquired by the priority acquisition section 44. In the present embodiment, the priority determination section 45 determines whether or not the acquired priority item indicates the “cost.”

As will be explained in detail later, in a case where the “cost” is selected, upon classification of test cases TC into test cases to be run for manual testing and test cases to be run for automated testing, the test case classification apparatus 3 preferentially classifies the test cases TC as those to be run for automated testing, to thereby reduce the total cost concerning a test based on all the test cases to be run.

On the other hand, in a case where the “quality” is selected, upon the classification of test cases TC into test cases to be run for manual testing and test cases to be run for automated testing, the test case classification apparatus 3 preferentially classifies the test cases TC as those to be run for manual testing, to thereby enhance the quality of the test.

The executable time calculation section 46 calculates an automated testing executable time that represents total hours of automated testing that can be executed before the end time of the test period, and a manual testing executable time that represents total hours of manual testing that can be executed before the end time of the test period.

Specifically, the executable time calculation section 46 calculates the automated testing executable time by multiplying the number of hours that is defined by a period of time in which automated testing can be executed between the start time and end time of the test period, with the number of test execution apparatuses that execute the automated testing, on the basis of the acquired test conditions.

In addition, the executable time calculation section 46 calculates the manual testing executable time by multiplying the number of hours that is defined by a period of time in which manual testing can be executed between the start time and end time of the test period, with the number of testers who execute the manual testing, on the basis of the acquired test conditions.

The total time calculation section 47 calculates a total automated testing time by totalizing the automated testing execution times included in the acquired test cases TC to be run. In addition, the total time calculation section 47 calculates a total manual testing time by totalizing the manual testing execution times included in the acquired test cases TC to be run. That is, the total time calculation section 47 calculates, as the total automated testing time, the amount of time required to execute automated testing based on all the test cases TC that are included in the acquired test cases TC to be run and that are classified as those to be run for automated testing. In addition, the total time calculation section 47 calculates, as the total manual testing time, the amount of time required to execute manual testing based on all the test cases TC that are included in the acquired test cases TC to be run and that are classified as those to be run for manual testing.

The time determination section 48 compares the automated testing executable time and the total automated testing time and determines whether or not the automated testing executable time is equal to or longer than the total automated testing time. In addition, the time determination section 48 compares the manual testing executable time and the total manual testing time and determines whether or not the manual testing executable time is equal to or longer than the total manual testing time.

The test case classification section 49 sets a running mode of each of the acquired test cases TC to be run and classifies each of the test cases TC as either a test case to be run through manual testing or a test case to be run through automated testing. Specifically, for each of the acquired test cases TC, the test case classification section 49 sets manual testing or automated testing as a running mode of a test based on the corresponding test case TC and classifies the relevant test case TC as either a test case to be run for manual testing or a test case to be run for automated testing. Here, the test case classification section 49 may create a manual testing list including the test cases TC having been classified as those to be run for manual testing, and create an automated testing list including the test cases TC having been classified as those to be run for automated testing. Alternatively, the test case classification section 49 may add the running mode, which is either “manual testing” or “automated testing,” to each test case TC on the basis of a result of the classification.

In a case where all the acquired test cases TC to be run fail to be completed within the test period under the inputted test conditions, the required number calculation section 50 calculates the number of test execution apparatuses required to automatically execute, within the test period, a test based on all the test cases TC to be run. That is, in a case where the abovementioned priority item is the “cost,” the required number calculation section 50 calculates the number of test execution apparatuses required to automatically complete, within the test period, the test based on all the test cases TC to be run.

In addition, in a case where a test based on all the acquired test cases TC to be run fails to be completed within the test period under the inputted test conditions, the required number calculation section 50 calculates the number of testers required to manually execute, within the test period, the test based on all the test cases TC to be run. That is, in a case where the abovementioned priority item is the “quality,” the required number calculation section 50 calculates the number of testers required to manually complete, within the test period, the test based on all the test cases TC to be run.

The result output section 51 outputs a result of the classification of the test cases TC to be run. Specifically, the result output section 51 provides a notification of the classification result to an operator of the test case classification apparatus 3, for example. It is to be noted that, in a case where all the acquired test cases TC fail to be completed within the test period under the inputted test conditions, the result output section 51 functions as a required number output section that outputs the required number calculated by the required number calculation section 50. It is to be noted that the notification from the result output section 51 may be given by email.

### Test Case Classification Process

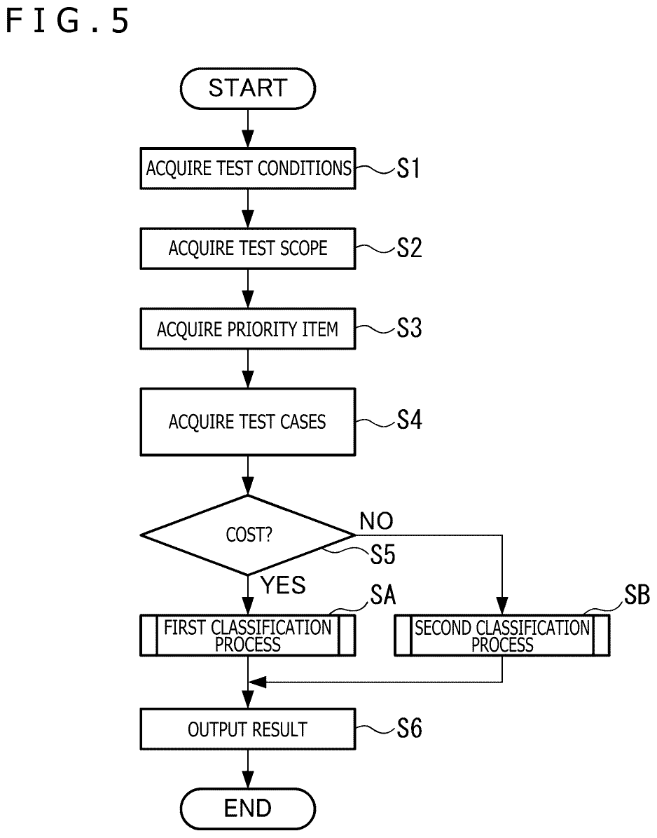

FIG. 5 is a flowchart of the test case classification process that is executed by the processor 4.

The processor 4 of the test case classification apparatus 3 reads out the test case classification program stored in the memory 35 and performs the test case classification process depicted in FIG. 5.

In the test case classification process, first, the test condition acquisition section 41 acquires test conditions inputted (step S1), the test scope acquisition section 42 acquires a test scope inputted (step S2), and the priority acquisition section 44 acquires a priority item inputted or selected (step S3). It is to be noted that the order of steps S1 to S3 can be changed appropriately.

Next, the test case acquisition section 43 acquires, as test cases to be run, test cases TC corresponding to the acquired test scope from the test case management server 2 (step S4).

Subsequently, the priority determination section 45 determines whether or not the acquired priority item is the “cost” (step S5).

When it is determined in step S5 that the priority item is the “cost” (step S5: YES), the processor 4 executes a first classification process SA.

When it is determined in step S5 that the priority item is not the “cost” (step S5: NO), the processor 4 executes a second classification process SB. In other words, when the priority determination section 45 determines that the priority item is the “quality,” the processor 4 executes the second classification process SB. Detailed explanations of the first classification process SA and the second classification process SB will be given later.

After the first classification process SA or the second classification process SB ends, the result output section 51 outputs a result of the classification, etc. (step S6).

Thereafter, the test case classification process ends.

### First Classification Process

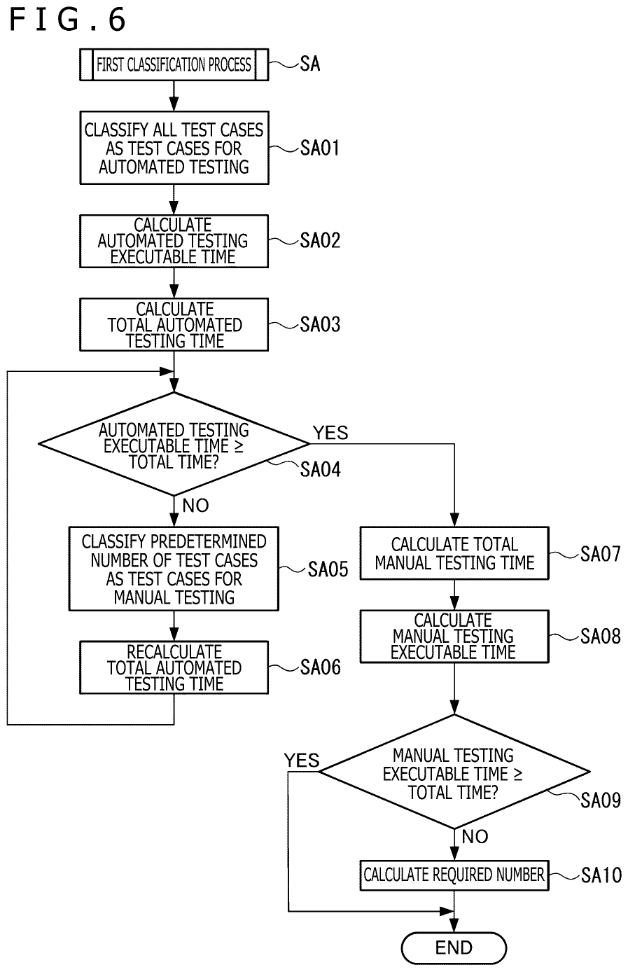

FIG. 6 is a flowchart of the first classification process SA.

The first classification process SA is part of the test case classification process. The first classification process SA is a process that is executed in a case where the priority item is the “cost,” to preferentially classify test cases to be run as test cases for automated testing. This process increases the proportion of automated testing in a test based on the test cases to be run.

In the first classification process SA, first, the test case classification section 49 classifies all the test cases TC included in the test cases to be run, as test cases for automated testing (step SA01), as depicted in FIG. 6. In other words, the test case classification section 49 sets automated testing as the running modes of all the test cases TC included in the test cases to be run.

Next, the executable time calculation section 46 calculates the automated testing executable time on the basis of the acquired test conditions (step SA02). By way of example, the test conditions are that the start date and time of the test period is 10:00 on November 2nd, the end date and time of the test period is 22:00 on November 4th, the number of test execution apparatuses is three, and a period of time in which automated testing can be executed by the test execution apparatuses is 6:00 to 23:00. In this case, one test execution apparatus can execute automated testing for 46 hours in the test period. Consequently, the automated testing executable time during which the three test execution apparatuses can execute automated testing is 46 hours×3 apparatuses=138 hours.

Next, the total time calculation section 47 calculates the total automated testing time by totalizing the automated testing execution times in the respective test cases TC included in the test cases to be run (step SA03).

Subsequently, the time determination section 48 determines whether or not the automated testing executable time is equal to or longer than the total automated testing time, by comparing the automated testing executable time with the total automated testing time (step SA04).

When it is determined in step SA04 that the automated testing executable time is not equal to or longer than the total automated testing time (step SA04: NO), the test case classification section 49 excludes a predetermined number of test cases TC from the test cases TC that are included in the test cases to be run and that are to be run for automated testing, and classifies the excluded test cases TC as those to be run for manual testing (step SA05). The predetermined number can be changed appropriately.

Here, the test case classification section 49 compares the manual testing execution time and the automated testing execution time for each of the test cases TC included in the test cases to be run and classifies a predetermined number of test cases TC selected from among the test cases TC in the which the manual testing execution time is shorter than the automated testing execution time, as those to be run for manual testing. In each of the test cases TC classified as those to be run for manual testing, the manual testing execution time is shorter than the automated testing execution time.

Moreover, the test case classification section 49 may extract, as test cases TC to be classified as those to be run for manual testing, test cases TC in which the difference between the manual testing execution time and the automated testing execution time is greater than a predetermined value, and classify a predetermined number of test cases TC selected from among the extracted test cases TC, as those to be run for manual testing.

It is to be noted that the test case classification section 49 may classify, as test cases to be run for manual testing, a predetermined number of test cases TC randomly selected from among the test cases TC classified as those to be run for automated testing.

After step SA05, the total time calculation section 47 recalculates the total automated testing time (step SA06). Here, the total time calculation section 47 calculates the total automated testing time by totalizing the automated testing execution times in the test cases TC excluding the test cases TC to be run for manual testing from the test cases to be run. That is, the total time calculation section 47 calculates the total automated testing time by totalizing the automated testing execution times in the test cases TC classified as those to be run for automated testing. It is to be noted that the total automated testing time calculated in step SA06 is shorter than the total automated testing time calculated in step SA03 because the test cases TC classified as those to be run for automated testing are reduced in step SA05.

After step SA06 ends, the processor 4 returns the process to step SA04.

When it is determined in step SA04 that the automated testing executable time is equal to or longer than the total automated testing time (step SA04: YES), the total time calculation section 47 calculates the total manual testing time by totalizing the manual testing execution times in the test cases TC excluding the test cases TC classified as those to be run for automated testing from the test cases to be run (step SA07). That is, in step SA07, the total time calculation section 47 calculates the total manual testing time by totalizing the manual testing execution times in the test cases TC classified as those to be run for manual testing.

It is to be noted that, in a case where the process proceeds to step SA07 without steps SA05 and SA06, all the test cases included in the test cases to be run have been classified as test cases to be run for automated testing. In this case, the total manual testing time calculated in step SA07 is zero hours.

Further, the executable time calculation section 46 calculates the manual testing executable time on the basis of the acquired test conditions (step SA08). By way of example, the test conditions include the abovementioned test period and test end time, the number of testers included in the test conditions is two, and a period of time in which manual testing can be executed by the testers is 9:00 to 12:00 and 13:00 to 17:00. In this case, one tester can execute manual testing for 20 hours in the test period. Consequently, the manual testing executable time of manual testing that can be executed by two testers is 20 hours×2 people=40 hours.

It is to be noted that step SA07 and step SA08 may concurrently be executed, or one of step SA07 and step SA08 may be followed by the other.

After steps SA07 and SA08, the time determination section 48 compares the total manual testing time calculated in step SA07 and the manual testing executable time calculated in step SA08 and determines whether or not the manual testing executable time is equal to or longer than the total manual testing time (step SA09).

When it is determined in step SA09 that the manual testing executable time is equal to or longer than the total manual testing time (step SA09: YES), the processor 4 determines that a test based on the test cases to be run can be completed within the test period by the test execution apparatuses in number specified in the test conditions and the testers in number specified in the test conditions, and then ends the first classification process SA. In this case, in step S6 of the test case classification process in FIG. 5, the result output section 51 outputs the completion of the classification of the test cases TC and a result of the classification performed by the test case classification section 49. Then, the processor 4 ends the test case classification process.

When it is determined in step SA09 that the manual testing executable time is not equal to or longer than the total manual testing time (step SA09: NO), the processor 4 determines that the test based on the test cases to be run may not be completed within the test period by the test execution apparatuses in number specified in the test conditions and the testers in number specified in the test conditions. That is, in a case where the manual testing executable time is shorter than the total manual testing time, the processor 4 determines that the test based on the test cases to be run may not be completed within the test period.

In this case, the required number calculation section 50 calculates the number of test execution apparatuses required to automatically execute a test based on all the test cases TC included in the test cases to be run (step SA10). Specifically, the required number calculation section 50 divides the total automated testing time calculated in step SA03, i.e., the total automated testing time obtained by totalizing the automated testing execution times in all the test cases TC included in the test cases to be run, by the number of hours in which one test execution apparatus can execute automated testing in the test period, rounds up the remainder, and uses the obtained quotient as the required number of test execution apparatuses.

Subsequently, the processor 4 ends the first classification process SA. In this case, in step S6 of the test case classification process in FIG. 5, the result output section 51 outputs the incompletion of the classification of the test cases TC and the required number of test execution apparatuses calculated in step SA10. Then, the processor 4 ends the test case classification process.

### Second Classification Process

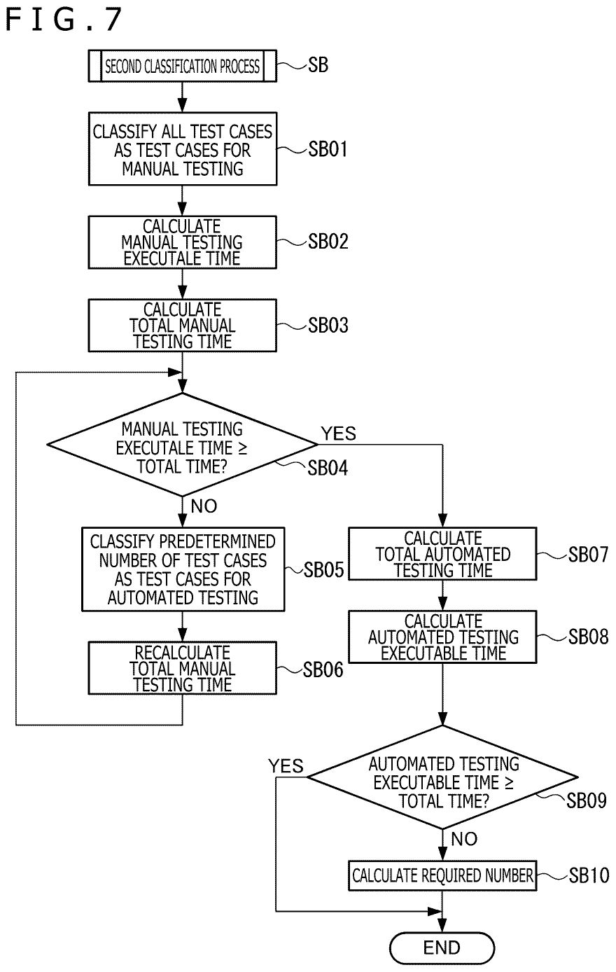

FIG. 7 is a flowchart of the second classification process SB.

Next, the second classification process SB will be explained.

The second classification process SB is part of the test case classification process. The second classification process SB is a process that is executed in a case where the priority item is the “quality,” to preferentially classify test cases to be run as test cases for manual testing. This process increases the proportion of manual testing in a test based on the test cases to be run.

In the second classification process SB, first, the test case classification section 49 classifies all the test cases TC included in the test cases to be run, as test cases for manual testing (step SB01), as depicted in FIG. 7. In other words, the test case classification section 49 sets manual testing as the running modes of all the test cases TC included in the test cases to be run.

Next, the executable time calculation section 46 calculates the manual testing executable time on the basis of the acquired test conditions (step SB02). In step SB02, the manual testing executable time is calculated by processing similar to that of step SA08.

Next, the total time calculation section 47 calculates the total manual testing time by totalizing the manual testing execution times in the respective test cases TC included in the test cases to be run (step SB03). It is to be noted that the running modes of all the test cases TC included in the test cases to be run have been set to manual testing at the time point of step SB03. Therefore, in step SB03, the total time calculation section 47 calculates the total manual testing time by totalizing the manual testing execution times in all the test cases TC.

Subsequently, the time determination section 48 determines whether or not the manual testing executable time is equal to or longer than the total manual testing time, by comparing the manual testing executable time with the total manual testing time (step SB04).

When it is determined in step SB04 that the manual testing executable time is not equal to or longer than the total manual testing time (step SB04: NO), the test case classification section 49 excludes a predetermined number of test cases TC from the test cases TC that are included in the test cases to be run and that are to be run for manual testing, and classifies the excluded test cases TC as those to be run for automated testing (step SB05). The predetermined number can be changed appropriately.

Here, the test case classification section 49 compares the manual testing execution time and the automated testing execution time for each of the test cases TC included in the test cases to be run and classifies a predetermined number of test cases TC selected from among the test cases TC in which automated testing execution time is equal to or shorter than the manual testing execution time, as test cases to be run for automated testing. That is, the test case classification section 49 classifies a predetermined number of test cases TC selected from among the test cases TC in which the manual testing execution time is longer than the automated testing execution time, as those to be run for automated testing. In each of the test cases TC classified as those to be run for automated testing, the automated testing execution time is equal to or shorter than the manual testing execution time.

Moreover, the test case classification section 49 may extract, as test cases TC to be classified as those to be run for automated testing, test cases TC in which the difference between the manual testing execution time and the automated testing execution time is greater than a predetermined value, and classify a predetermined number of test cases TC selected from among the extracted test cases TC, as those to be run for automated testing.

It is to be noted that the test case classification section 49 may classify, as test cases to be run for automated testing, a predetermined number of test cases TC randomly selected from among the test cases TC classified as those to be run for manual testing.

After step SB05, the total time calculation section 47 recalculates the total manual testing time (step SB06). Here, the total time calculation section 47 calculates the total manual testing time by totalizing the manual testing execution times in the test cases TC excluding the test cases TC to be run for automated testing from the test cases to be run. That is, the total time calculation section 47 calculates the total manual testing time by totalizing the manual testing execution times in the test cases TC classified as those to be run for manual testing. It is to be noted that the total manual testing time calculated in step SB06 is shorter than the total manual testing time calculated in step SB03 because the test cases TC classified as those to be run for manual testing are reduced in step SB05.

After step SB06 ends, the processor 4 returns the process to step SB04.

When it is determined in step SB04 that the manual testing executable time is equal to or longer than the total manual testing time (step SB04: YES), the total time calculation section 47 calculates the total automated testing time by totalizing the automated testing execution times in the test cases TC excluding the test cases TC classified as those to be run for manual testing from the test cases to be run (step SB07). That is, processing similar to that of step SA06 is executed in step SB07 to calculate the total automated testing time.

It is to be noted that, in a case where the process proceeds to step SB07 without steps SB05 and SB06, all the test cases included in the test cases to be run have been classified as test cases to be run for manual testing. In this case, the total automated testing time calculated in step SB07 is zero hours.

In addition, the executable time calculation section 46 calculates the automated testing executable time on the basis of the acquired test conditions (step SB08). Specifically, in step SB08, the executable time calculation section 46 calculates the automated testing executable time by executing the processing similar to that of step SA06.

It is to be noted that step SB07 and step SB08 may concurrently be executed, or one of step SB07 and step SB08 may be followed by the other.

After steps SB07 and SB08, the time determination section 48 compares the total automated testing time calculated in step SB07 and the automated testing executable time calculated in step SB08 and determines whether or not the automated testing executable time is equal to or longer than the total automated testing time (step SB09).

When it is determined in step SB09 that the automated testing executable time is equal to or longer than the total automated testing time (step SB09: YES), the processor 4 determines that a test based on the test cases to be run can be completed within the test period by the testers in number specified in the test conditions and the test execution apparatuses in number specified in the test conditions, and then ends the second classification process SB. In this case, in step S6 of the test case classification process in FIG. 5, the result output section 51 outputs the completion of the classification of the test cases TC and a result of the classification performed by the test case classification section 49. Then, the processor 4 ends the test case classification process.

When it is determined in step SB09 that the automated testing executable time is not equal to or longer than the total automated testing time (step SB09: NO), the processor 4 determines that the test based on the test cases to be run may not be completed within the test period by the testers in number specified in the test conditions and the test execution apparatuses in number specified in the test conditions. That is, in a case where the automated testing executable time is shorter than the total automated testing time, the processor 4 determines that the test based on the test cases to be run may not be completed within the test period.

In this case, the required number calculation section 50 calculates the number of testers required to manually execute a test based on all the test cases TC included in the test cases to be run (step SB10). Specifically, the required number calculation section 50 divides the total manual testing time calculated in step SB03, i.e., the total manual testing time obtained by totalizing the manual testing execution times in all the test cases TC included in the test cases to be run, by the number of hours in which one tester can execute manual testing in the test period, rounds up the remainder, and uses the obtained quotient as the required number of testers.

Subsequently, the processor 4 ends the second classification process SB. In this case, in step S6 of the test case classification process in FIG. 5, the result output section 51 outputs the incompletion of the classification of the test cases TC and the required number of testers calculated in step SB10. Then, the processor 4 ends the test case classification process.

### Effects of Embodiment

The test case classification system 1 according to the present embodiment explained so far provides the following effects.

The test case classification apparatus 3 includes the memory 35 and the processor 4.

The processor that executes the test case classification program includes the test case classification section 49 and the result output section 51.

The test case classification section 49 performs classification of one test case that is included in test cases describing test contents for system software, by comparing the manual testing execution time and the automated testing execution time in the one test case and setting the running mode of the one test case. That is, the test case classification section 49 sets either manual testing or automated testing as the running mode of the test case, and accordingly classifies the test case as either a test case to be run for manual testing or a test case to be run for automated testing. It is to be noted that the manual testing execution time represents the amount of time required to manually execute a test based on one test case, and the automated testing execution time represents the amount of time required to automatically execute a test based on one test case.

The result output section 51 outputs a result of the classification performed by the test case classification section 49.

With this configuration, whether a test case is to be run for manual testing or for automated testing can be determined on the basis of the manual testing execution time and the automated testing execution time in the relevant test case. Then, the test case classification section 49 can classify a test case in which the manual testing execution time is shorter than the automated testing execution time, as a test case to be run for manual testing, and classify a test case in which the manual testing execution time is equal to or longer than the automated testing execution time, as a test case to be run for automated testing, for example. As a result, the amount of time required to execute a test based on a plurality of test cases can be shortened. Consequently, the classification of test cases can be performed so as to complete the test within the test period.

In the test case classification apparatus 3, the test case classification section 49 classifies in step SA05 a test case in which the manual testing execution time is shorter than the automated testing execution time, as a test case to be run for manual testing, for example. In addition, the test case classification section 49 classifies in step SB05 a test case in which the manual testing execution time is equal to or longer than the automated testing execution time, as a test case to be run for automated testing, for example.

With this configuration, manual testing or automated testing that takes a shorter execution time can be selected for a certain test case as the running mode thereof. Accordingly, the abovementioned required time can be shortened.

In the test case classification apparatus 3, the processor 4 includes the test condition acquisition section 41 that acquires a test period, the required number calculation section 50, and the result output section 51.

The test condition acquisition section 41 includes the function of the test period acquisition section.

The required number calculation section 50 calculates in step SAS10 the number of test execution apparatuses required to complete, within the test period, test cases classified by the test case classification section 49 as those to be run for automated testing, for example. It is to be noted that, in step SA10, the required number calculation section 50 calculates the number of such test execution apparatuses on condition that the test cases TC included in the test cases to be run have all been classified as those to be run for automated testing.

In step S6 subsequent to the first classification process SA, the result output section 51, which corresponds to the required number output section, outputs the number of test execution apparatuses calculated by the required number calculation section 50.

With this configuration, for example, an operator of the test case classification apparatus 3 or a test manager can easily recognize the required number of test execution apparatuses. Accordingly, with the test execution apparatuses prepared in number corresponding to the outputted number, automated testing based on the test cases classified as those to be run for automated testing can be completed within the test period.

In the test case classification apparatus 3, the processor 4 includes the test condition acquisition section 41 that acquires a test period, the required number calculation section 50, and the result output section 51.

The test condition acquisition section 41 includes the function of the test period acquisition section.

The required number calculation section 50 calculates in step SB10 the number of testers required to complete, within the test period, test cases classified by the test case classification section 49 as those to be run for manual testing, for example. It is to be noted that, in step SB10, the required number calculation section 50 calculates the number of such testers on condition that the test cases TC included in the test cases to be run have all been classified as those to be run for manual testing.

In step S6 subsequent to the second classification process SB, the result output section 51, which corresponds to the required number output section, outputs the number of testers calculated by the required number calculation section 50.

With this configuration, for example, an operator of the test case classification apparatus 3 or a test manager can easily recognize the required number of testers. Accordingly, with the testers prepared in number corresponding to the outputted number, manual testing based on the test cases classified as those to be run for manual testing can be completed within the test period.

In the test case classification apparatus 3, a test case TC includes a manual testing execution time and an automated testing execution time.

With this configuration, the manual testing execution time and the automated testing execution time can be obtained from a test case acquired. Accordingly, acquisition of the manual testing execution time and the automated testing execution time can be performed more quickly than a case where these execution times are acquired separately from the test case, and acquisition of the execution times concerning a different test case can also be suppressed. Consequently, the processing time for classification of the test cases TC can be shortened.

### Modifications of Embodiment

The present disclosure is not limited to the abovementioned embodiment, and modifications and improvements thereof are within the scope of the present disclosure as long as they can achieve an object of the present disclosure.

In the above embodiment, the test case classification section 49 classifies the running modes of the test cases TC included in the test cases to be run, into manual testing and automated testing, on the basis of the test conditions inputted to the input unit 31 and then acquired by the test condition acquisition section 41. However, the configuration is not limited thereto, and the processor 4 including the test case classification section 49 may classifies the running modes of the test cases TC according to predetermined conditions.

By way of example, by comparing the manual testing execution time and the automated testing execution time included in a test case TC, the test case classification section 49 of the processor 4 may determine whether to set manual testing or automated testing as the running mode of this test case TC. In this case, the test case classification section 49 may set automated testing as the running mode of a test case TC that is one of the test cases TC included in the test cases to be run and in which automated testing execution time is equal to or shorter than the manual testing execution time, and may set manual testing as the running mode of a test case TC in which automated testing execution time is longer than the manual testing execution time, for example. In this case, a running mode of a test based on the test cases TC included in the test cases to be run can be set such that the test can be executed within the minimum time.

In the above embodiment, the test conditions include a test period specified by the start date and time and the end date and time, the number of testers who can execute manual testing, a period of time in which manual testing can be executed by the testers, the number of test execution apparatuses capable of executing automated testing, and a period of time in which automated testing can be executed by the test execution apparatuses. However, the test conditions are not limited thereto, and may omit at least one of the test period, the number of testers, the period of time in which manual testing can be executed, the number of test execution apparatuses, and the period of time in which automated testing can be executed, or may further include any other condition.

In the above embodiment, each test case TC includes the manual testing execution time that represents the amount of time required to execute manual testing and the automated testing execution time that represents the amount of time required to execute automated testing. However, the configuration is not limited thereto, and the manual testing execution time and the automated testing execution time are not necessarily included in a test case TC as long as they are associated with the test case TC. For example, in the test case management server 2 or the test case classification apparatus 3, the manual testing execution time and the automated testing execution time may be held separately from the test case TC.

In the above embodiment, the required number calculation section 50 calculates the number of test execution apparatuses required to automatically execute a test based on all the test cases included in the test cases to be run, and calculates the number of testers required to manually execute the test based on all the test cases included in the test cases to be run. However, the configuration is not limited thereto, and the processor 4 may not calculate the required number of test execution apparatuses or may not calculate the required number of testers.

In the above embodiment, the processor 4 is configured such that the required number calculation section 50 calculates the required number of test execution apparatuses or testers in a case where a test based on the test cases to be run fails to be completed within the test period, and the result output section 51 outputs and provides a notification of the required number of test execution apparatuses or testers. However, the configuration is not limited thereto, and the processor 4 may provide a notification of at least either the required number of test execution apparatuses or the required number of testers when acquiring the test conditions or the priority item, for example. In this case, the processor 4 may cause a display device included in the test case classification apparatus 3 to display a notification including at least either one of the numbers. That is, the style of the notification provided by the processor 4 can be changed appropriately.

In the above embodiment, the processor 4 executes either the first classification process SA or the second classification process SB on the basis of the priority item inputted to the input unit 31 and then acquired by the priority acquisition section 44. Specifically, in a case where the priority item is the “cost,” the processor 4 executes the first classification process SA, which can be regarded as an automated testing preferential classification that preferentially sets automated testing as the running mode of a test case TC. In a case where the priority item is the “quality,” the processor 4 executes the second classification process SB, which can be regarded as a manual testing preferential classification that preferentially sets manual testing as the running mode of a test case TC. However, the configuration is not limited thereto, and the processor 4 may execute one of the first classification process SA and the second classification process SB on the basis of any other information. By way of example, when the priority item is “automated testing,” the processor 4 may execute the first classification process SA, and when the priority item is “manual testing,” the processor 4 may execute the second classification process SB.

In the above embodiment, the test cases TC each include a manual testing execution time and an automated testing execution time. However, the configuration is not limited thereto, and the test case TC may include a level representing the amount of time required for manual testing and a level representing the amount of time required for automated testing, for example.

In the above embodiment, in step SA10, the required number calculation section 50 calculates the number of test execution apparatuses that can automatically complete, within the test period, a test based on all the test cases TC included in the test cases to be run. In addition, in step SB10, the required number calculation section 50 calculates the number of testers that can manually complete, within the test period, a test based on all the test cases TC included in the test cases to be run. However, the configuration is not limited thereto. For example, when the automated testing executable time is determined to be equal to or longer than the total automated testing time in step SA04, the required number calculation section 50 may calculate the number of test execution apparatuses that can complete automated testing based on the test cases TC classified as those to be run for automated testing within the test period, on the basis of the acquired test conditions. At a timing when the number of such test execution apparatuses is calculated, the result output section 51 may then output the number of test execution apparatuses. In addition, for example, when the manual testing executable time is determined to be equal to or longer than the total manual testing time in step SB04, the required number calculation section 50 may calculate the number of testers that can complete manual testing based on the test cases TC classified as those to be run for manual testing within the test period, on the basis of the acquired test conditions. At a timing when the number of such testers is calculated, the result output section 51 may then output the number of testers.

### Summery of Present Disclosure

A summary of the present disclosure is as follows.

[1] A test case classification apparatus including:
a memory; and
a processor, in which
the processor includes
   a test case classification section that performs classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case, and
a result output section that outputs a result of the classification performed by the test case classification section.

With this configuration, whether a test case is to be run for manual testing or for automated testing can be determined on the basis of the manual testing execution time and the automated testing execution time in the relevant test case. Then, the test case classification section can classify a test case in which the manual testing execution time is shorter than the automated testing execution time, as a test case to be run for manual testing, and classify a test case in which the manual testing execution time is equal to or longer than the automated testing execution time, as a test case to be run for automated testing, for example. As a result, the amount of time required to execute a test based on a plurality of test cases can be shortened. Accordingly, the classification of test cases can be performed so as to complete the test within a test period.

[2] The test case classification apparatus according to [1], in which
the test case classification section
   classifies the test case in which the manual testing execution time is shorter than the automated testing execution time, as a test case to be run for manual testing, and
   classifies the test case in which the manual testing execution time is equal to or longer than the automated testing execution time, as a test case to be run for automated testing.

With this configuration, manual testing or automated testing that takes a shorter execution time can be selected for a certain test case as the running mode thereof. Accordingly, the abovementioned required time can be shortened.

[3] The test case classification apparatus according to [2], in which
the processor includes
   a test period acquisition section that acquires a test period,
   a required number calculation section that calculates the number of test execution apparatuses required to complete, within the test period, the test case classified by the test case classification section as the test case to be run for automated testing, and
   a required number output section that outputs the number of the test execution apparatuses calculated by the required number calculation section.

With this configuration, for example, an operator of the test case classification apparatus or a test manager can easily recognize the required number of test execution apparatuses. Accordingly, with the test execution apparatuses prepared in number corresponding to the outputted number, automated testing based on the test cases classified as those to be run for automated testing can be completed within the test period.

[4] The test case classification apparatus according to [2]or [3], in which
the processor includes
   a test period acquisition section that acquires a test period,
a required number calculation section that calculates the number of testers required to complete, within the test period, the test case classified by the test case classification section as the test case to be run for manual testing, and
a required number output section that outputs the number of the testers calculated by the required number calculation section.

With this configuration, for example, an operator of the test case classification apparatus or a test manager can easily recognize the required number of testers. Accordingly, with the testers prepared in number corresponding to the outputted number, manual testing based on the test cases classified as those to be run for manual testing can be completed within the test period.

[5]The test case classification apparatus according to any one of [1] to [4], in which
the test case includes the manual testing execution time and the automated testing execution time.

With this configuration, the manual testing execution time and the automated testing execution time can be obtained from a test case acquired. Therefore, acquisition of the manual testing execution time and the automated testing execution time can be performed more quickly than a case where these execution times are acquired separately from the test case. Further, acquisition of the execution times concerning a different test case can also be suppressed. Accordingly, the processing time for classification of the test cases can be shortened.

[6] A test case classification program for a computer including a memory and a processor, including:
by a test case classification section, performing classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case; and
by a result output section, outputting a result of the classification performed by the test case classification section.

The program is executed by the computer, so that the same advantageous effects as those of the abovementioned test case classification apparatus can be provided.

1. A test case classification apparatus comprising:
a processor; and
a memory, containing instructions, that cause the processor to perform operations comprising:
performing classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case, and
outputting a result of the classification.

2. The test case classification apparatus according to claim 1, wherein the operations further comprise:
classifying the test case in which the manual testing execution time is shorter than the automated testing execution time, as a test case to be run for manual testing, and
classifying the test case in which the manual testing execution time is equal to or longer than the automated testing execution time, as a test case to be run for automated testing.

3. The test case classification apparatus according to claim 2, wherein the operations further comprise:
acquiring a test period,
calculating a number of test execution apparatuses required to complete, within the test period, the test case to be run for automated testing, and
outputting the number of the test execution apparatuses.

4. The test case classification apparatus according to claim 2, wherein the operations further comprise:
acquiring a test period,
calculating a number of testers required to complete, within the test period, the test case classified as the test case to be run for manual testing, and
outputting the number of the testers

5. The test case classification apparatus according to claim 1, wherein the test case includes the manual testing execution time and the automated testing execution time.

6. A method comprising:
performing classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case; and
outputting a result of the classification.

7. A non-transitory computer-readable storage medium having stored thereon instructions that, when executed by one or more processors, cause the one or more processors to perform operations, comprising:
performing classification of one test case that is included in test cases describing test contents for system software, by comparing a manual testing execution time representing an amount of time required to manually execute a test based on the one test case and an automated testing execution time representing an amount of time required to automatically execute the test and setting a mode of running the one test case; and
outputting a result of the classification.
